(19) United States
(12) Patent Application Publication
(10) Pub. No.: US 2016/0059805 A1
(43) Pub. Date: Mar. 3, 2016

(54) Method For Automatically Enclosing An Open Vehicle

(71) Applicant: Nicholas Menchaca, Summerville, SC (US)

(72) Inventor: Nicholas Menchaca, Summerville, SC (US)

(21) Appl. No.: 14/686,348

(22) Filed: Apr. 14, 2015

Related U.S. Application Data
(60) Provisional application No. 62/042,098, filed on Aug. 26, 2014.
(60) Provisional application No. 62/073,750, filed on Oct. 31, 2014.

(51) Int. Cl. B60R 16/03; B60J 7/00; B60J 7/185

(52) U.S. Cl. CPC B60R 16/03; B60J 7/185; B60J 7/00

(57) ABSTRACT

At least one sensor mounted to an open vehicle such as a convertible can be connected into a circuit with a power source and a motorized roof portion. The sensor is able to determine the presence of conditions such as clouds, rain, or night, by recording and measuring a stimulus. If the measured stimulus crosses a predetermined threshold, a switch closes in order to complete the circuit. The completed circuit thus supplies power to the motorized roof portion, resulting in the motorized roof portion closing without direct human manipulation. In addition to the motorized roof portion, a motorized window and a power lock can be electrically connected into the circuit. As a result, not only can the motorized roof portion be automatically closed, the motorized window can automatically be closed and the power lock can be automatically locked.

The current application claims a priority to the U.S. Provisional Patent application Ser. No. 62/042,098 filed on Aug. 26, 2014 and a priority to the U.S. Provisional Patent application Ser. No. 62/073,750 filed on Oct. 10, 2014.

### FIELD OF THE INVENTION

The present invention relates generally to a method for protecting vehicles, utilizing an installed system. More specifically, the present invention is designed to protect a vehicle with a fabric convertible top or a hard shell type convertible top, and is also applicable with sun roofs and moon roofs.

### BACKGROUND OF THE INVENTION

For many of the same reason vehicles such as convertibles are popular, they are susceptible to several drawbacks that do not apply to fixed roof cars. Convertibles, whether with a hard top or soft top, as well as other vehicles with sun and moon roofs, are prone to having these areas damaged or destroyed by weather. Vandalism can also be a concern for vehicle owners, especially if the owner forgets to enclose the vehicle at night. Though some solutions exist to these problems, many solutions are not an option for large segments of the population. For example, while parking in a secured garage would protect the vehicle from both inclement weather and vandalism, many car owners do not have a garage available. There exists a need for a method of automatically enclosing an open vehicle which is easily implemented.

The present invention is provided to protect an open vehicle by means of a combination of sensors which are connected with a power source and motorized roof portion (e.g. convertible top, sun roof, or moon roof) of the vehicle. The present invention is also capable of ensuring that windows are rolled up and doors are locked in the presence of low light conditions, providing a safeguard against owners who forget to secure their vehicle at night.

### BRIEF DESCRIPTION OF THE DRAWINGS

FIG. 1 is a flowchart outlining the core process concept of the present invention.

FIG. 2 is an illustration showing an open vehicle in conditions in which a sensor is not triggered.

FIG. 3 is an illustration showing the open vehicle in conditions which have triggered a sensor configured to detect low light levels, such as caused by clouds, resulting in a motorized roof portion automatically closing.

FIG. 4 is an illustration showing the open vehicle in conditions which have triggered a sensor configured to detect moisture levels, such as caused by rain, resulting in the motorized roof portion automatically closing.

FIG. 5 is an illustration showing the open vehicle in a situation where motion of a person has triggered the sensor configured to detect motion, resulting in the motorized roof portion automatically closing in order to prevent potential theft.

FIG. 6 is an illustration showing the open vehicle in conditions which have triggered the sensor configured to detect low light levels, in this example because of nightfall, resulting in the motorized roof portion automatically closing.

FIG. 7 is an illustration showing the open vehicle in conditions which have triggered the sensor configured to detect low light levels, in this example because of nightfall, which would normally result in the motorized roof portion automatically closing, but the automatic closing is overridden due to the presence of occupants in the open vehicle.

### DETAIL DESCRIPTIONS OF THE INVENTION

All illustrations of the drawings are for the purpose of describing selected versions of the present invention and are not intended to limit the scope of the present invention.

The present invention is provided to allow open vehicles such as convertibles to be automatically enclosed in a number of different scenarios. By utilizing a system that can close a convertible roof when certain conditions are detected, the convertible roof can be closed without requiring direct input from a person. A few examples of situations where the present invention is utilized include cloudy weather, wet weather, and nighttime. The present invention will automatically close the convertible roof in such situations, helping to protect the interior of the vehicle from rain, or simply making sure the convertible roof is closed when the owner goes to sleep.

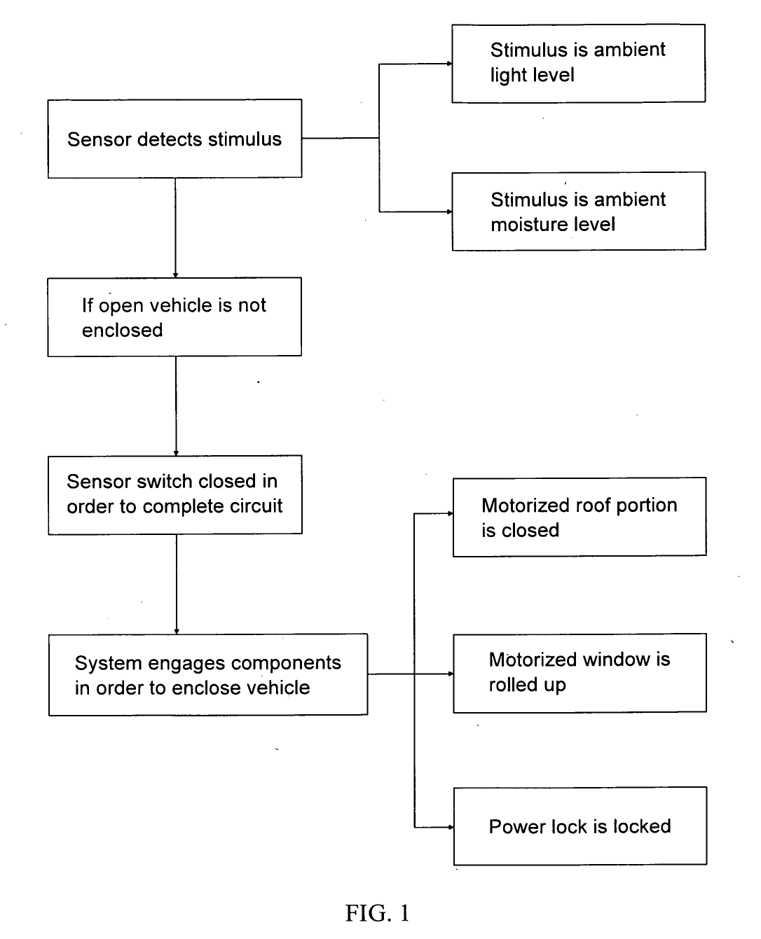

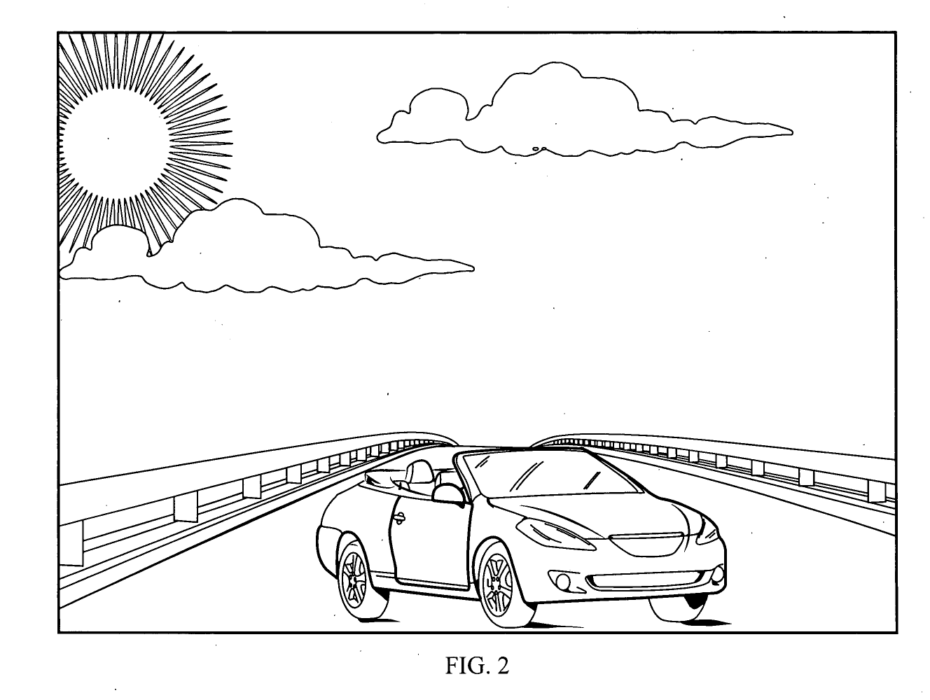

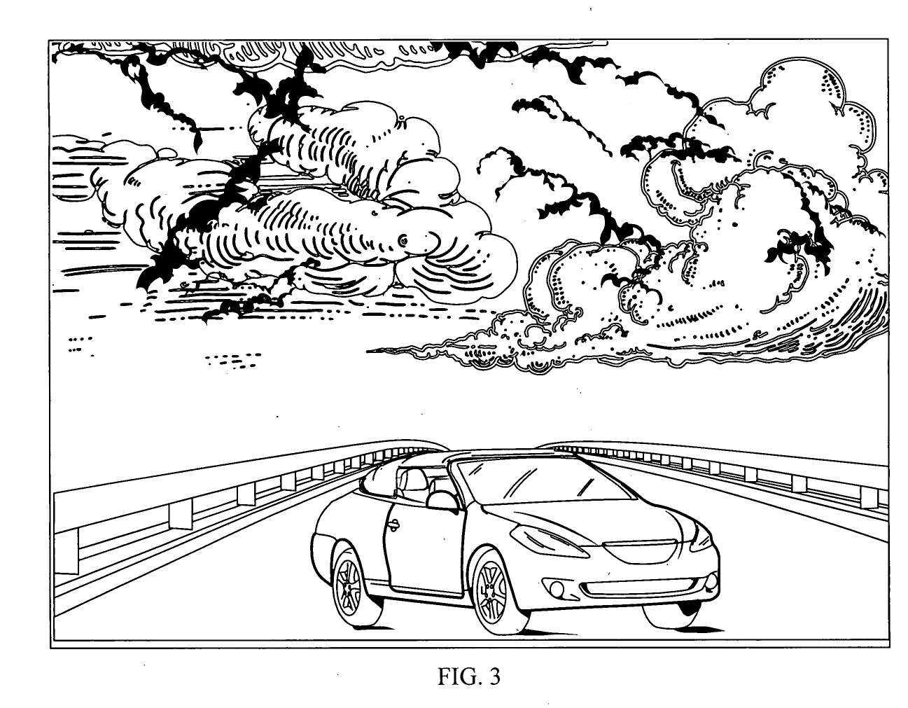

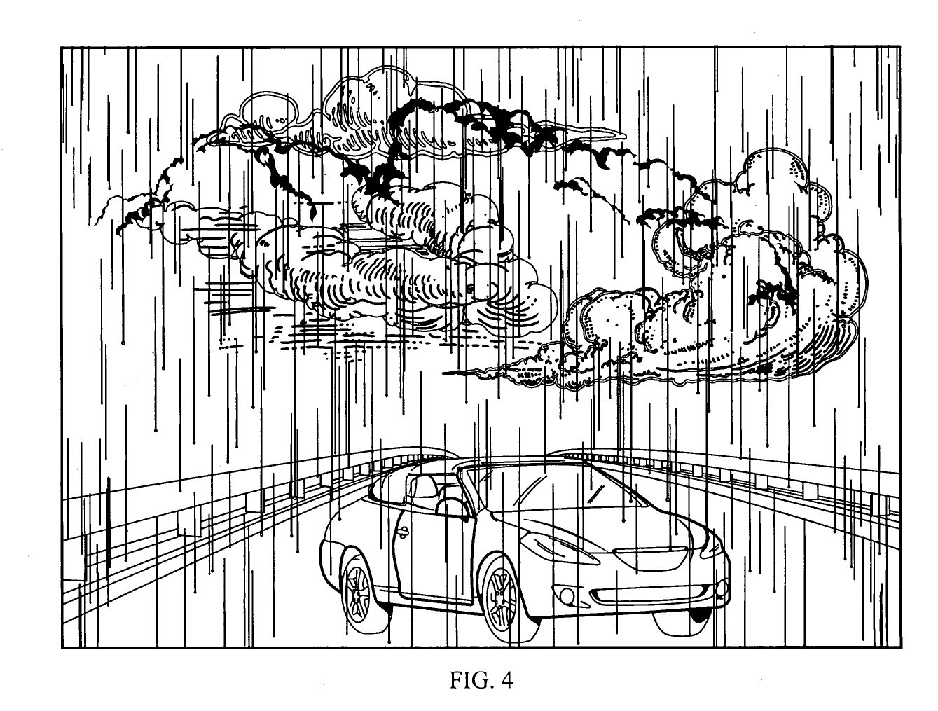

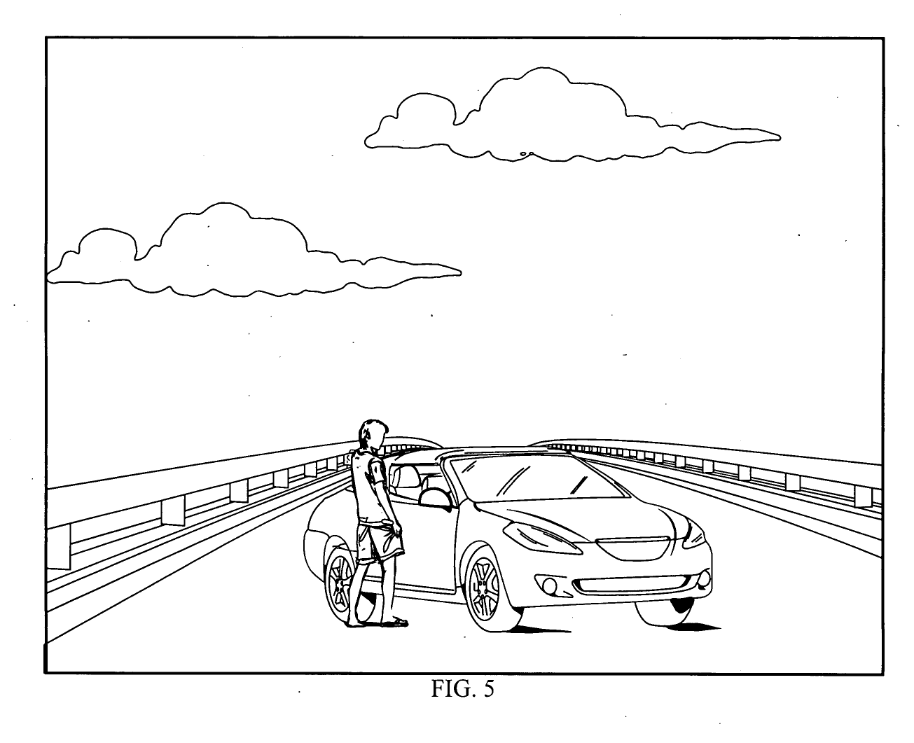

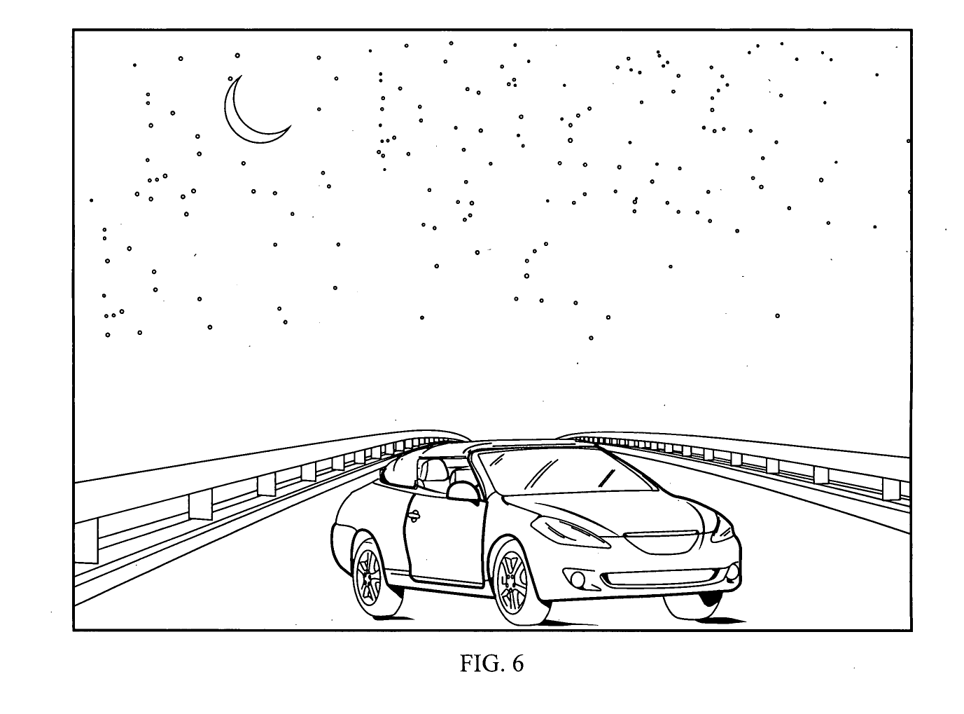

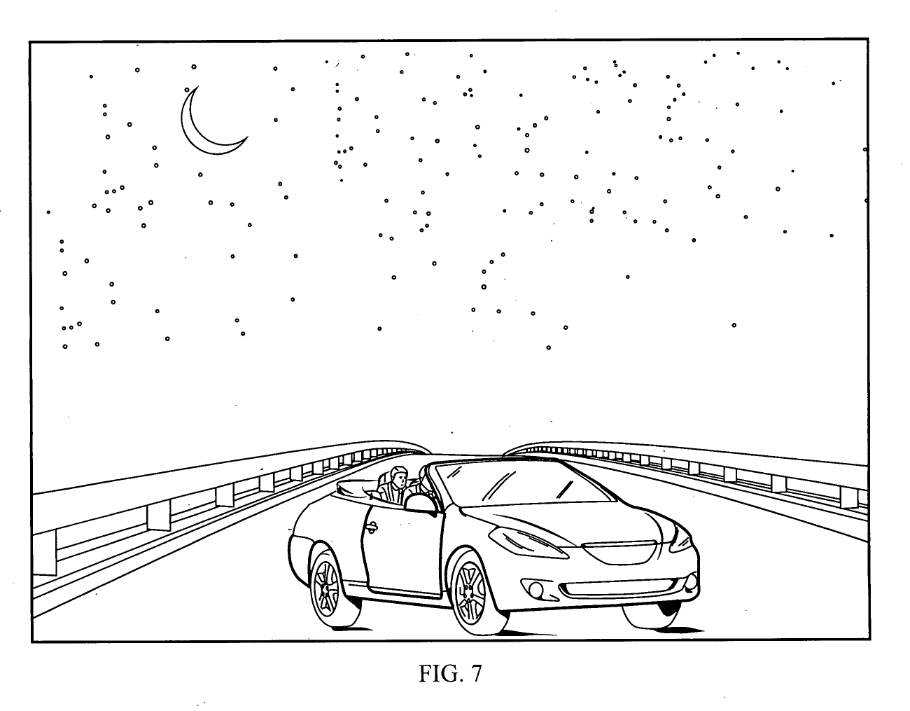

Elaborating upon the concept of the present invention in more detail, a provided electronic system is utilized to automatically enclose an open vehicle (e.g. the aforementioned convertible) in the presence of certain ambient conditions. By providing a sensor mounted to the open vehicle, a sensor switch, and a power source, a circuit can be created between a motorized roof portion, the sensor switch, and the power source. The basic method of the present invention entails several steps related to the above components. The process of the present invention is initiated when the sensor detects a stimulus. When this stimulus is detected, the sensor switch is closed, completing the electrical connection between the motorized roof portion and the power source. This allows power to be supplied to the motorized roof portion, which is engaged once power is enabled. This motorized roof portion is then able to transition from an open configuration (e.g. a convertible roof which is retracted) to a closed configuration (e.g. a closed convertible roof). This outlines the basic process of enclosing the open vehicle in response to ambient environmental conditions. The basic steps of the process is illustrated in FIG. 1, while FIG. 2-FIG. 7 provide examples of the system automatically enclosing the vehicle in different environmental conditions.

Preferably, in order to prevent potential damage to the motorized roof portion, the circuit is only completed if the motorized roof portion is in an open configuration when the stimulus is detected by the sensor. Engaging the motorized roof portion when it is already in a closed configuration results in unnecessary power drain from the power source, as well as wear and tear on the drive mechanism. By only engaging the motorized roof portion when it is in an open configuration, the present invention helps to maximize lifespan of the motorized roof portion.

The present invention as thus far described provides a general description of how the motorized roof portion of an open vehicle can automatically be enclosed in the presence of certain conditions. Expanding upon this core process of the present invention, other vehicle components can also be adjusted by the present invention. Examples of such components include a motorized window (often referred to as “power windows”) and a power lock. Just as the motorized roof portion can automatically be enclosed by the system, so can the motorized window and the power lock. This is enabled by electrically connecting at least one motorized window, at least one power lock, or even both, to the circuit. As a result, the present invention can automatically close a convertible roof, roll up the convertible windows, and lock the convertible doors when certain environmental conditions are detected. The process of operating these components as related to the present invention is subsequently described in more specifically.

The at least one motorized window is electrically connected into the circuit, such that it can receive power from the power source when the circuit is completed (i.e. all switches of the circuit are closed). This electrical connection allows the at least one motorized window to be engaged once the circuit has been completed. Once engaged, the motorized window is able to transition from an open position to a closed position. Effectively, the present invention automatically “rolls up” the motorized window in response to the circuit being completed.

The at least one power lock, parallel to the motorized window, is electrically connected into the circuit. When the circuit is completed, the power lock is engaged in response. Resultantly, the power lock transitions from an unlocked position to a locked position. Effectively, the present invention automatically locks the power lock in response to the circuit being completed.

Preferably, just as the motorized roof portion is only engaged when the motorized roof portion is in the open configuration, the motorized window and the power lock are only engaged when in a open position and locked position, respectively. By only engaging the motorized window and the power lock when necessary (i.e. they are not already closed or locked), the present invention minimizes unnecessary wear, tear, and power expenditure.

While the motorized window and the power lock have been described as being singular, multiple motorized windows and power locks can be electrically connected into the circuit. In fact, it is preferable that all the motorized windows and power locks of an open vehicle are electrically connected into the circuit, ensuring that the open vehicle is completely enclosed and secured by the present invention.

As described, the present invention automatically encloses and secures an open vehicle when the corresponding circuit is completed. Reviewing the circuit, a sensor switch of a sensor closes to complete the circuit when the sensor is triggered. The sensor can be triggered by a number of conditions, including ambient moisture or ambient light. Based on ambient light levels, ambient moisture levels, or even both, the sensor is capable of determining whether conditions are sunny, cloudy, or raining. The sensor can also effectively differentiate daytime from night time, based on the ambient light levels. The present invention is thus able to determine whether it is necessary to enclose the open vehicle through utilization of the sensor.

Elaborating upon the process of the sensor detecting a stimulus and resultantly closing the sensor switch, a measured value of the stimulus is first recorded. The measured value quantifies the ambient conditions and is compared with a second value to determine whether the ambient conditions are at a level that require enclosing the open vehicle (and hence closing the sensor switch).

The second value is a threshold value. The threshold value, determined in advance, provides a value that is selected to represent the border between two conditions. For example, the threshold value for moisture is a value that represents the change from “raining” to “not raining” or vice versa. The measured value is compared to this threshold value to determine whether a certain condition should trigger the sensor and close the sensor switch. When the measured value crosses the threshold value, the sensor is triggered and the sensor switch is closed in order to complete the circuit. As a result, the present invention automatically enclosed the open vehicle in response to changes in ambient conditions.

One condition preferably measured by the present invention is the earlier referenced ambient light level. In this scenario, the stimulus measured by the sensor is the ambient light level. Correspondingly, the threshold value is a threshold light level. When the measured ambient light level crosses the threshold level, the present invention automatically encloses the open vehicle. This is because the measured ambient light level indicates a change in environmental conditions, whether the presence of clouds or the transition from daytime to nighttime.

Another condition preferably measured by the present invention is the earlier referenced ambient moisture level, in which case the stimulus measured by the sensor is the ambient moisture level. The threshold value, accordingly, is a threshold moisture level. When the measured ambient moisture level crossed the threshold value, the open vehicle is automatically enclosed by the present invention. This is in response to changing environmental conditions, such as the presence of rain, the changing conditions being indicated by the measured moisture level. Measuring moisture is provided as a backup means; ideally, rain will be proceeded by clouds which will reduce ambient light levels and cause the motorized roof portion to automatically close. However, in the event that the ambient light sensor is not triggered before rainfall begins, the moisture sensor will minimize potential damage by detecting the rain and automatically closing the motorized roof portion.

An additional potential condition monitored by the system is nearby motion, accomplished by providing a motion sensor as the at least one sensor. The stimulus detected by this motion sensor is a proximal motion, for example a person's hand reaching into the vehicle cabin. The system monitors for such activity in order to prevent potential theft; in response to detecting motion, the system encloses and secures the car by completing the circuit and automatically closing the motorized roof portion, motorized window, and power locks.

The motion sensor itself can be implemented as a passive motion sensor or an active motion sensor. A passive motion sensor functions by measuring quantified environmental conditions, for example infrared energy. A human body approaching the vehicle triggers a rapid change in the measured ambient infrared energy; this is the basic operational concept of a passive motion sensor. The passive motion sensor is preferably configured to measure infrared energy as emitted by humans; while the motion sensor could potentially be used to automatically enclose the open vehicle in response to animal presences, it is primarily provided to prevent theft.

An active motion sensor, rather than measuring ambient conditions, creates a phenomenon in the ambient conditions which can then be used to detect motion. Examples of the phenomenon include a laser beam and radar waves. The laser beam example detects motion when the laser beam is broken; providing a beam generator is directed towards the active motion sensor, the active motion sensor will detect the laser beam as long as no objects or persons interfere with the path. If the path is broken, the active motion sensor no longer detects the beam generator, indicating an attempted theft.

Comparatively, the radar example detects attempted theft by emitting radar waves and detecting reflected radar waves. A change in the reflected radar waves indicates attempted theft, as the change in reflected radar waves results from an object disrupting the normal reflection of radar waves.

The above provides just a few examples of how a motion sensor can be implemented; these and other types of motion sensors can be utilized in combination with the present invention as long as they are capable of detecting motion and closing the open vehicle in response.

Regardless of type of stimulus is measured by the sensor, the sensor allows the open vehicle to be enclosed in response to changing conditions. The enclosing of the vehicle can be transitioning the motorized roof portion to a closed configuration, transitioning the motorized window to a closed position, transitioning the power lock to a locked position, or a combination thereof. While the invention, to this point, has described the sensor as being singular, multiple sensors can be utilized. At least one sensor is required, but that sensor may be configured to detect ambient light levels or ambient moisture levels. Preferably, multiple sensors are utilized, with at least one being configured to detect ambient light levels and another one being configured to detect ambient moisture levels. These are just a few examples of possible sensors; additional sensors could be provided to detect other environmental conditions.

If multiple sensors are utilized, the present invention can require multiple stimuli to be detected in order to close the circuit. For example, if one sensor is configured to detect ambient light levels, and another is configured to detect ambient moisture levels, the circuit is configured such that a sensor switch from each sensor is closed in order to complete the circuit. If only one sensor needs to be triggered, then the multiple sensors could share a single sensor switch which is electrically connected into the circuit. Alternatively, the sensor switches could be electrically connected in parallel, such that the circuit is completed as long as any one of the sensor switches is closed.

Potentially, the threshold values may be adjustable, such that they can be adapted to the personal preferences of different vehicle owners. For example, someone who uses their vehicle more in the evening may tend to drive at later times than another person, and thus prefer that the top does not automatically close at dusk. For such a person, the threshold value for measured ambient level could be adjusted to be lower than a default value. Resultantly, the open vehicle would not be enclosed by means of the present invention until a later time. This is just one example of how an adjustable threshold value can be beneficial.

Furthermore, the threshold value of the sensors could instead by a threshold range. Because ambient conditions normally undergo gradual transitions, rather than instantly switching between states, the present invention may compare the measured ambient level against a threshold range rather than a threshold value. The sensor would only be triggered if the measured ambient level crosses the threshold range, rather than a single threshold value. Essentially, the threshold range results in a tolerance of the sensor, as it would not be triggered based on a single value. Ultimately, the process of the present invention can be carried out with either the threshold value or the threshold range. Other ways of determining how the sensor is triggered are also possible, with the key process being the sensor switch being closed in response to a detected stimulus.

In addition to monitoring ambient conditions through the sensor, the present invention checks to see if the vehicle is occupied before automatically enclosing the vehicle. This step is carried out by means of a provided weight sensor, the weight sensor having a corresponding sensor switch which is electrically connected into the circuit. The weight sensor is placed in a seat of the open vehicle, allowing it to determine if a person is sitting the corresponding seat. A measured weight value is recorded with the weight sensor, the measured weight value then being compared to a threshold value. The threshold value is a predetermined weight value; if the measured weight value crosses this threshold value, it indicates the presence of a person in the vehicle. In order to allow the person to if and when the open vehicle should be enclosed, the weight sensor breaks the circuit by opening a corresponding sensor switch. This prevents the circuit from being completed regardless of other circumstances, for example the sensor being triggered by a stimulus. The results is that the automatic aspect of the present invention is suspended when the vehicle is occupied, leaving full control of the vehicle along with its motorized roof portion, motorized window, and power lock to the occupant.

While the present invention has been described in conjunction with a convertible as the open vehicle, it is not limited such. The motorized roof portion can certainly be embodied as a convertible cover, like in the convertible example, but may also be embodied as a sun roof or a moon roof. Open vehicles with a sun roof or moon roof, as opposed to a convertible cover, are just as capable of benefitting from the present invention. The present invention is applicable to convertibles with both “soft tops”, e.g. such as made from a fabric material, and “hard tops”, e.g. such as made from a rigid material.

The components utilized by the method of the present invention can be provided in a number of ways, including as a standalone unit which is installed in a vehicle or as an integrated system a vehicle is shipped with. The power source of the present invention serves as a hub for the other components, specifically the sensors, the sensor switches, and the automated components i.e. motorized roof portion, motorized window, and power lock. The power can be provided through a number of means, such as a standalone battery or electrically connecting the system to the alternator of the vehicle Likewise, the specific positioning of the sensors is variable, as they could potentially be mounted to the front, sides, rear, or even inside the cabin of the vehicle. The only restriction regarding positioning of the sensors is that they must be capable of detecting the stimulus; for example, a sensor configured to detect ambient light levels should not be positioned in a glove box, but rather somewhere that is not obstructed from the ambient light.

The position of the weight sensor is more restricted than that of the other sensors. It is preferably housed in a seat of the vehicle, such that it will be able to measure the weight of a person sitting on the seat. If the weight sensor is not positioned in the seat, it must be positioned where it is still capable of recording a measured weight value.

Although the invention has been explained in relation to its preferred embodiment, it is to be understood that many other possible modifications and variations can be made without departing from the spirit and scope of the invention as hereinafter claimed.

What is claimed is:

1. A method for automatically enclosing an open vehicle comprises the steps of:
providing a motorized roof portion of the vehicle, an at least one sensor mounted to the open vehicle, a sensor switch of the sensor, and a power source;
providing the sensor switch, the motorized roof portion, and the power source being electrically connected into a circuit;
detecting a stimulus with the at least one sensor;
closing the sensor switch in order to complete the circuit in response to detecting the stimulus,
if the motorized roof portion is in an open configuration;
engaging the motorized roof portion in response to the circuit being completed; and
transitioning the motorized roof portion from the open configuration into a closed configuration as a result of the motorized roof portion being engaged.

2. The method for automatically enclosing an open vehicle as claimed in claim 1 comprises the steps of:
providing an at least one motorized window of the open vehicle, the motorized window being electrically connected into the circuit;
engaging the at least one motorized window in response to the circuit being completed,
if the at least one motorized window is in an open position; and
transitioning the at least one motorized window from the open position to a closed position.

3. The method for automatically enclosing an open vehicle as claimed in claim 1 comprises the steps of:
providing an at least one power lock of the open vehicle, the at least one power lock being electrically connected into the circuit;
engaging the at least one power lock in response to the circuit being completed,
if the at least one power lock is in an unlocked position; and
transitioning the at least one power lock from the unlocked position to a locked position.

4. The method for automatically enclosing an open vehicle as claimed in claim 1 comprises the steps of:
recording a measured value of the stimulus;
comparing the measured value to a threshold value; and
closing the sensor switch,
if the measured measure value crosses the threshold value.

5. The method for automatically enclosing an open vehicle as claimed in claim 1, wherein:
the stimulus is an ambient light level and the at least one sensor is configured to measure the ambient light level.

6. The method for automatically enclosing an open vehicle as claimed in claim 1, wherein:
the stimulus is an ambient moisture level and the at least one sensor is configured to measure the ambient moisture level.

7. The method for automatically enclosing an open vehicle as claimed in claim 1, wherein:
the stimulus is a proximal motion and the at least one sensor is configured to detect the proximal motion.

8. The method for automatically enclosing an open vehicle as claimed in claim 7, wherein:
the at least one sensor is a passive motion sensor.

9. The method for automatically enclosing an open vehicle as claimed in claim 7, wherein:
the at least one sensor is an active motion sensor.

10. The method for automatically enclosing an open vehicle as claimed in claim 1 comprises the steps of:
providing at least one weight sensor and a sensor switch thereof, the sensor switch being electrically connected into the circuit, wherein the at least one weight sensor is housed in a seat of the open vehicle;
recording a measured weight value with the weight sensor;
comparing the measured weight value to a threshold value; and
opening the sensor switch in order to break the circuit,
if the weight value crosses the threshold value.

11. The method for automatically enclosing an open vehicle as claimed in claim 1, wherein:
the motorized roof portion is a convertible cover.

12. The method for automatically enclosing an open vehicle as claimed in claim 1, wherein:
the motorized roof portion is a sun roof.

13. The method for automatically enclosing an open vehicle as claimed in claim 1, wherein:
the motorized roof portion is a moon roof.
